(19) United States
(12) Patent Application Publication
(10) Pub. No.: US 2010/0299140 A1
(43) Pub. Date: Nov. 25, 2010

(54) IDENTIFYING AND ROUTING OF DOCUMENTS OF POTENTIAL INTEREST TO SUBSCRIBERS USING INTEREST DETERMINATION RULES

(75) Inventors: Michael John Witbrock, Austin, TX (US); Lawrence Seth Lefkowitz, Leander, TX (US); David Andrew Schneider, Austin, TX (US); Kevin Blake Shepard, Austin, TX (US); Marko Grobelnik, Ljubljana (SI); Blaz Fortuna, Ljubljana (SI); Dunja Mladenic, Ljubljana (SI)

Correspondence Address: WINSTEAD PC, P.O. BOX 50784, DALLAS, TX, 75201, US

(73) Assignee: CYCORP, INC., Austin, TX (US)

(21) Appl. No.: 12/783,675

(22) Filed: May 20, 2010

Related U.S. Application Data
(60) Provisional application No. 61/180,710, filed on May 22, 2009.

(51) Int. Cl. G06F 17/27

(52) U.S. Cl. 704/9

(57) ABSTRACT

A method, system and computer program product for identifying documents of interest. A profile of a subscriber is created based on information obtained about the subscriber. Subscriber-interest determination rules are used to identify potential topics of interest of the subscriber based on the subscriber's profile as well as based on external knowledge sources. Each potential interest of the subscriber may be represented by a pointer that references a concept. Additionally, concepts in the documents published by the publishers are identified. A comparison may be made between the concepts identified in the documents published by the publishers with those concepts representing the potential topics of interests of the subscriber. Those documents with matching concepts may then be identified as potentially being of interest for the subscriber. In this manner, documents of interest are more accurately identified for the document seeker.

### CROSS-REFERENCE TO RELATED APPLICATIONS

This application is related to the following commonly owned co-pending U.S. patent application:

Provisional Application Ser. No. 61/180,710, “Model-Based System and Method for Intelligent Information Dissemination,” filed May 22, 2009, and claims the benefit of its earlier filing date under 35 U.S.C. §119(e).

### TECHNICAL FIELD

The present invention relates to identifying documents of interest, and more particularly to identifying and routing of documents of potential interest to subscribers using interest determination rules.

### BACKGROUND OF THE INVENTION

The continuing rapid growth of the quantity and scope of textual information available via the Internet and other computer networks makes it ever more challenging to identify documents of interest to a particular person or organization. Often, a user seeking documents of interest enters various keywords or phrases in a query. A text search may then be employed to identify documents that match the keywords or phrases entered by the user. However, identifying documents in such a manner imposes a burden on the searcher to provide specific query seeking data. Furthermore, the documents identified by such a search may not be relevant or of interest to the user since the search only attempts to match the keywords or phrases entered by the user with the document content. For example, a user may enter the term “bat” in a query and documents related to flying mammals may be identified. However, the user may instead be interested in the game of baseball. As a result of simply identifying documents based on identical textual keywords or phrases, the search may not be accurate and not produce documents of interest.

Therefore, there is a need in the art for more accurately identifying documents of interest to the document seeker.

### BRIEF SUMMARY OF THE INVENTION

In one embodiment of the present invention, a method for identifying documents of interest comprises identifying potential topics of interests of a subscriber based on a profile of the subscriber and knowledge sources using subscriber-interest determination rules, where the potential topics of interests are represented as pointers to concepts. The method further comprises identifying concepts contained in each of a plurality of documents. Additionally, the method comprises associating each identified concept with that document. Furthermore, the method comprises comparing the identified concepts in the plurality of documents with the concepts representing the potential topics of interests of the subscriber. In addition, the method comprises identifying one or more documents in the plurality of documents whose concepts match with the concepts representing the potential topics of interests of the subscriber.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWING

A better understanding of the present invention can be obtained when the following detailed description is considered in conjunction with the following drawings, in which:

FIG. 1 illustrates an embodiment of the present invention of a publisher/subscriber system;

FIG. 2 illustrates an embodiment of the present invention of an intelligent information disseminator;

FIG. 3 illustrates the software components used in identifying and routing documents of potential interest to subscribers using interest determination rules in accordance with an embodiment of the present invention; and

FIG. 4 is a flowchart of a method for identifying documents of interest in accordance with an embodiment of the present invention.

### DETAILED DESCRIPTION OF THE INVENTION

The present invention comprises a method, system and computer program product for identifying documents of interest. In one embodiment of the present invention, a profile of a subscriber is created based on information obtained about the subscriber. Subscriber-interest determination rules are used to identify potential topics of interest of the subscriber based on the subscriber's profile as well as based on external knowledge sources. Each potential interest of the subscriber may be represented by a pointer that references a concept. Additionally, concepts in the documents published by the publishers are identified. A comparison may be made between the concepts identified in the documents published by the publishers with those concepts representing the potential topics of interests of the subscriber. Those documents with matching concepts may then be identified as potentially being of interest for the subscriber. In this manner, documents of interest are more accurately identified for the document seeker.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

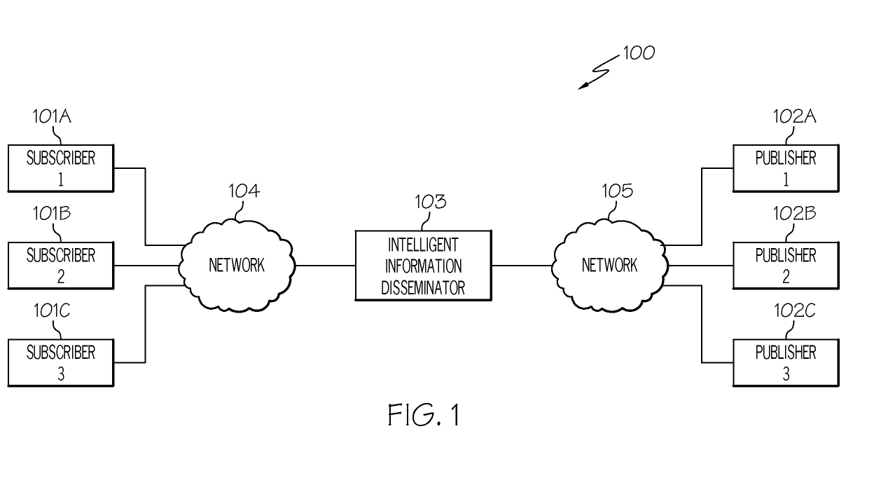

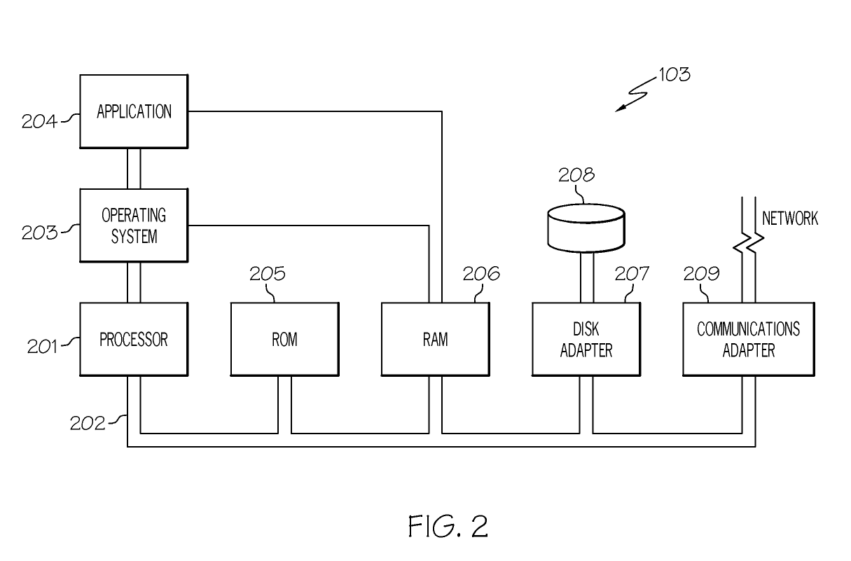

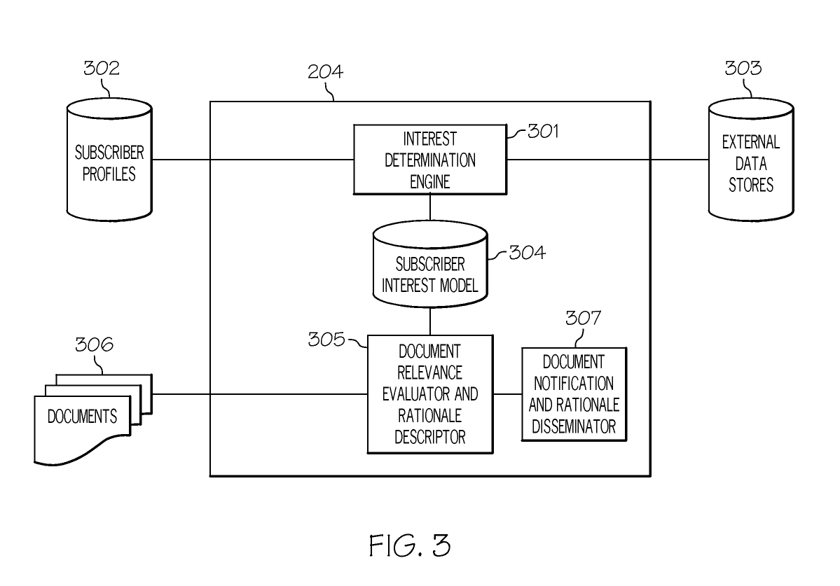

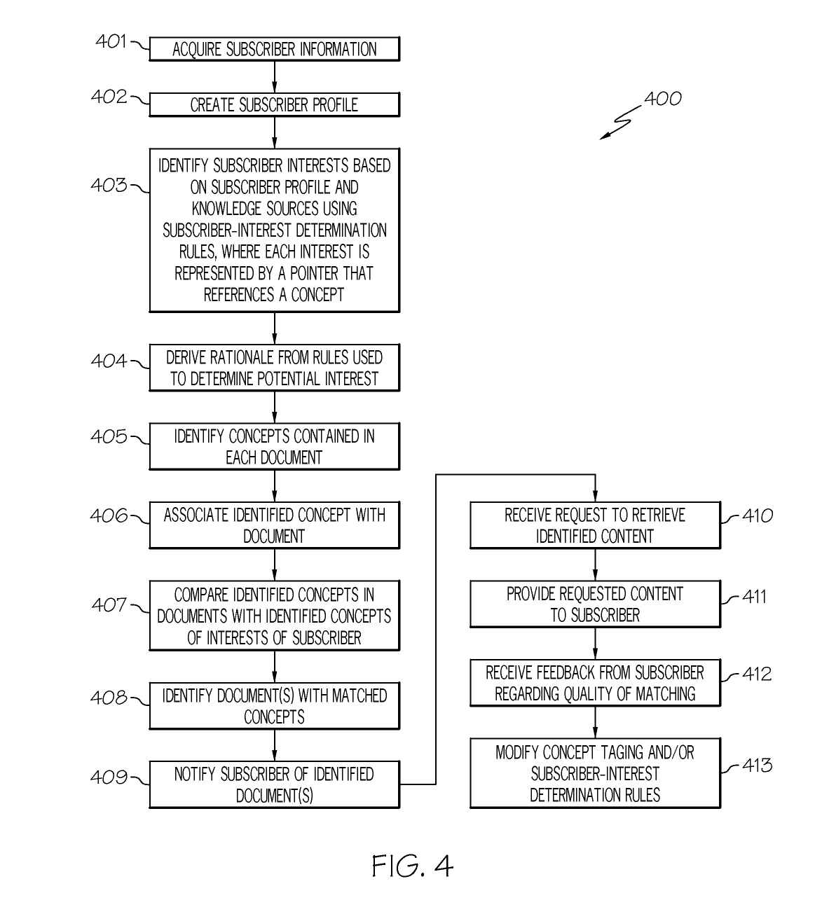

As stated in the Background section, the continuing rapid growth of the quantity and scope of textual information available via the Internet and other computer networks makes it ever more challenging to identify documents of interest to a particular person or organization. Often, a user seeking documents of interest enters various keywords or phrases in a query. However, identifying documents in such a manner imposes a burden on the searcher to provide specific query seeking data. Furthermore, as a result of simply identifying documents based on identical textual keywords or phrases, the search may not be accurate and not produce documents of interest. Therefore, there is a need in the art for more accurately identifying documents of interest to the document seeker. The principles of the present invention accurately identify documents of interests for the document seeker in a publisher/subscriber environment as discussed below in connection with FIGS. 1-4. FIG. 1 illustrates a publisher/subscriber environment. FIG. 2 illustrates an intelligent information disseminator. FIG. 3 illustrates the software components used in identifying and routing documents of potential interest to subscribers using interest determination rules. FIG. 4 is a flowchart of a method for identifying documents of interest.

As discussed above, the principles of the present invention may be applied to what is referred to herein as a “publisher/subscriber” environment. Referring to FIG. 1, FIG. 1 illustrates an embodiment of the present invention of a publisher/subscriber system 100. Publisher/subscriber system 100 may include one or more subscribers 101A-C and one or more publishers 102A-C. Subscribers 101A-C may collectively or individually be referred to as subscribers 101 or subscriber 101, respectively. Publishers 102A-C may collectively or individually be referred to as publishers 102 or publisher 102, respectively. FIG. 1 is not to be limited in scope to any particular number of subscribers 101 or publishers 102.

A subscriber 101, as used herein, may refer to a client system whose user seeks documents of interest. “Documents,” as used herein, may refer to textual documents, non-textual documents with textual annotations (e.g., captioned photographs, audio or video files with accompanying transcripts), text embedded in spreadsheets, other structured information or non-textual documents that have been annotated with machine readable concepts (e.g., geographical information). By way of illustration, and without imitation, the types of documents may include: news or other contemporaneous articles; social networking posting and streams (e.g., Twitter™, Facebook™, Digg™); advertisements; product or service information; media content; technical bulletins; bug or virus reports; laws and regulations; job postings and resumes; calls for proposals; patents and patent applications; etc.

A publisher 102, as used herein, may refer to a provider of documents as discussed above. Publisher 102 includes originators and developers of documents as well as organizers of the world's information. For example, publisher 102 may include, but not limited to, search engines (e.g., Google™, Yahoo™), online news organizations, social networking websites, etc.

Publisher/subscriber system 100 may further include what is referred to herein as an “intelligent information disseminator” 103. Intelligent information disseminator 103 may be coupled to subscribers 101 and publishers 102 via networks 104, 105, respectively. Networks 104, 105 may refer to a Local Area Network (LAN) (e.g., Ethernet, Token Ring, ARCnet), or a Wide Area Network (WAN) (e.g., Internet).

Intelligent information disseminator 103 is configured to identify and route documents published by publishers 102 that are of potential interest to the user of subscriber 101 as discussed further below. A more detail description of an embodiment of a configuration of intelligent information disseminator 103 is provided below in connection with FIG. 2. FIG. 1 is not to be limited in scope to any particular embodiment and publisher/subscriber system 100 may be any system that includes at least one subscriber 101, at least one publisher 102 and intelligent information disseminator 103.

FIG. 2 illustrates an embodiment of a hardware configuration of intelligent information disseminator 103 which is representative of a hardware environment for practicing the present invention. Referring to FIG. 2, intelligent information disseminator 103 may have a processor 201 coupled to various other components by system bus 202. An operating system 203 may run on processor 201 and provide control and coordinate the functions of the various components of FIG. 2. An application 204 in accordance with the principles of the present invention may run in conjunction with operating system 203 and provide calls to operating system 203 where the calls implement the various functions or services to be performed by application 204. Application 204 may include, for example, an application for identifying and routing of documents of potential interest to subscribers using interest determination rules as discussed below in association with FIGS. 3 and 4.

Referring again to FIG. 2, read-only memory (“ROM”) 205 may be coupled to system bus 202 and include a basic input/output system (“BIOS”) that controls certain basic functions of intelligent information disseminator 103. Random access memory (“RAM”) 206 and disk adapter 207 may also be coupled to system bus 202. It should be noted that software components including operating system 203 and application 204 may be loaded into RAM 206, which may be intelligent information disseminator's 103 main memory for execution. Disk adapter 207 may be an integrated drive electronics (“IDE”) adapter that communicates with a disk unit 208, e.g., disk drive. It is noted that the program for identifying and routing of documents of potential interest to subscribers using interest determination rules as discussed below in association with FIGS. 3 and 4, may reside in disk unit 208 or in application 204.

Intelligent information disseminator 103 may further include a communications adapter 209 coupled to bus 202. Communications adapter 209 may interconnect bus 202 with an outside network (not shown) thereby allowing intelligent information disseminator 103 to communicate with subscribers 101, publishers 102.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” ‘module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to product a machine, such that the instructions, which execute via the processor of the computer or other programmable data processing apparatus, create means for implementing the function/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the function/acts specified in the flowchart and/or block diagram block or blocks.

As discussed above, application 204 may include, for example, an application for identifying and routing of documents of potential interest to subscribers using interest determination rules. The software components of application 204 used in identifying and routing of documents of potential interest to subscribers is discussed below in connection with FIG. 3.

FIG. 3 illustrates the software components used in identifying and routing documents of potential interest to subscribers 101 using interest determination rules in accordance with an embodiment of the present invention. Referring to FIG. 3, in conjunction with FIGS. 1 and 2, application 204 may include an interest determination engine 301. Interest determination engine 301 is configured to identify potential interests of subscriber 101 using logical rules, referred to herein as “subscriber-interest determination rules,” based on information provided by subscriber 101 which are stored in profiles (labeled as “subscriber profiles” in FIG. 3), such as in a database 302. Furthermore, interest determination engine 301 may also use external knowledge sources (e.g., social network sites (e.g., Facebook™ MySpace™, LinkedIn™), talk-focused sites or applications that may contain relevant information about subscriber 101 (e.g., Doppler™.com, Meetup™.com, Mint™.com, Quicken™, Last.fm, Google™ Health, etc.), commerce-oriented sites (e.g., Amazon™.com, eBay™.com, etc.) or other structured descriptions of personal information such as FOAF (Friend of a Friend) files), referred to herein as “external data stores” 303, to obtain information about subscriber 101 which may be stored in the subscriber profiles. Furthermore, interest determination engine 301 may use external data stores 303 to obtain additional knowledge beyond that provided by subscriber 101 or about subscriber 101 that is used to determine potential interests of subscriber 101 as discussed further below. For example, suppose that subscriber 101 indicated in his/her profile that he/she was a fan of the television show Magnum P.I. External data stores 303 may contain information indicating that the star of the television show Magnum P.I. was Tom Selleck. This information may be used by interest determination engine 301 to determine subscriber's 101 potential interests based on the application of subscriber-interest determination rules.

Subscriber-interest determination rules may be thought of as a series of IF-THEN statements, an example of which is provided further below. These rules may be applied to the information stored in the subscriber's profile as well as in external data stores 303 to generate a fact or what may be referred to herein as an “assertion.” The assertion relates to a potential topic of interest for subscriber 101, where each topic of interest may have a pointer referencing what is referred to herein as a “concept.”

For example, the following illustrates a subscriber-interest determination rule paraphrased in English with rule variables shown as upper case words starting with a question mark:

```
If?USER is a shareholder in ?COMPANY, and
  ?COMPANY is in ?INDUSTRY and
  ?AGENCY regulates ?INDUSTRY and
  ?CONCEPT is an administrator for ?AGENCY
Then ?USER may be interested in ?CONCEPT
```

The inferred interests for each subscriber 101 are determined by applying some or all of the interest-determination rules to the profile information as well as information available in external data stores 303. By way of illustration, if the above sample rule were applied to subscriber Pat Smith (?USER), whose profile indicates that he owns shares of Verizon™ (?COMPANY), a reasoning process with access to the appropriate knowledge base and data sources might determine that Verizon™ is in the telecommunications industry (?INDUSTRY), that the Federal Communications Commission (?AGENCY) regulates telecommunications, and that Michael J. Copps (?CONCEPT) is an administrator for the FCC. Based on this information, one may infer that subscriber Pat Smith may be interested in documents that mention Michael J. Copps. The result of applying the subscriber-interest determination rules is known as an assertion. In this case, the assertion is that Pat Smith may potentially be interested in documents that mention Michael J. Copps. Each assertion may be added to what is referred to herein as a “subscriber interest model” 304. In one embodiment, the assertion may be represented by a pointer, such as a uniform resource indicator (URI), that references some world concept (e.g., Michael J. Copps). Each concept may have a unique identifier.

In another example, as discussed above, suppose that subscriber 101 indicates in his/her profile that he/she enjoys watching the television show Magnum P.I. Interest determination engine 301 may obtain information from external data stores 303 that indicates that Tom Selleck was the star of Magnum P.I. Interest-determination engine 301 may apply a subscriber-interest determination rule that states that subscribers may potentially be interested in documents that discuss the main star of television shows subscribers enjoy watching. Hence, in the Magnum P.I. example, interest determination engine 301 may generate an assertion that subscriber 101 may potentially be interested in articles about Tom Selleck. This assertion will be added to subscriber interest model 304.

In one embodiment, assertions are added to subscriber interest model 304 utilizing predicate calculus. Each assertion (or axiom) in the model represents a relationship between subscriber 101 and some real-world concepts or concepts. For example, referring to the above example involving Pat Smith, if subscriber Pat Smith owns a Delorean automobile, then the model could include an assertion of the form: (ownsObjectType Pat Smith DeloreanCar).

The assertions in subscriber interest model 304 may be assigned to one or more categories with such categorization providing potential value to, at least, the organization of information during the acquisition and presentation of the subscriber profile and the reasoning process whereby a subscriber's potential interests are inferred. In one embodiment, the assignment of profile assertions to categories may be specified manually. In another embodiment, the assignment of profile assertions may be determined automatically based on the content of the assertion.

In one embodiment, the assertions in subscriber interest model 304 may be represented in a structured fashion, such as an extensible markup language (XML) or a resource description framework (RDF) file or in a relational database, as a collection of potential interesting concepts or combinations of concepts, for subscriber 101 along with a rationale for the potential interest, and, optionally, an assessment of the probability or conditional probability of that interest. The included rationale may be derived from the application of the subscriber-interest determination rule(s) used to determine the potential interest. By way of one the above examples, the rationale for Pat Smith's potential interest in Michael J. Copps would contain the information that Copps is a regulator of the FCC which regulates an industry (telecommunications) in which Pat Smith owns stock (Verizon™).

A more detail description of interest determination engine 301 as well as the subscriber-interest determination rules and subscriber interest model 304 will be discussed below in connection with FIG. 4.

Application 204 may further include document relevance evaluator and rationale descriptor 305. In one embodiment, document relevance evaluator and rationale descriptor 305 identifies the concepts contained in the documents 306 produced by publishers 102. The identified concepts are then associated with that document. The process of identifying and associating concepts to documents 306 may be referred to herein as “concept tagging.” In one embodiment, the concepts to be identified in documents 306 produced by publishers 102 may be the totality of the concepts identified for subscribers 101. Since the identification of additional concepts in documents may not benefit the matching of the documents to subscribers 101, extraneous concepts may be removed from the concept tagging lexicon to improve its efficiency. Additionally, where sources of information containing terms of interest to a particular subscriber 101 can be identified, the relevant terms may be added to the lexicon. By way of illustration, if subscriber 101 is determined to have a potential interest in officers of an agency (e.g., the FCC), then databases or other structured information sources may be queried for the officers of that particular agency and that information added to the concept tagging lexicon.

Document relevance evaluator and rationale descriptor 305 further determines which of these documents 306 produced by publishers 102 with concepts identified are of potential interest to subscribers 101. That is, once a given document produced by publisher 102 is conceptually tagged, the concepts associated with that document are compared with the interest sets of current subscribers 101. Where there is a match, or a match that exceeds some match-quality threshold, the document is deemed of potential interest to the matching subscribers 101, if any.

Application 204 may further include document notification and rationale disseminator 307 which notifies subscriber 101 of the document(s) that are deemed to be of potential interest as well as the rationale(s) forming the basis in determining that these document(s) are of potential interest. In one embodiment, document notification and rationale disseminator 307 presents the document(s) in its notification. In one embodiment, document notification and rationale disseminator 307 may notify subscriber 101 of those document(s) of potential interest to subscriber 101 using various notification channels, such as, but not limited to, electronic mail; inclusion of the document in a really simple syndication (RSS) feed; instant messaging (IM), short message service (SMS), or other text messages (e.g., Twitter™); inclusion in a blog or other website. The notification content may vary depending on the notification channel and may include any or all of the following: the title of the matched document; a uniform resource locator (URL) or other pointer to the document; the full text of the document, with or without the concept tags; the rationale by which the document was determined to be appropriate for the particular subscriber (or a URL or other pointer to that rationale). In the embodiment where pointers (or links) to information are included in the notification, subscriber 101 may easily click on or otherwise activate those links so as to retrieve the indicated content.

A more detailed explanation of the application of these components is provided below in connection with FIG. 4.

FIG. 4 is a flowchart of a method 400 for identifying documents of interest in accordance with an embodiment of the present invention.

Referring to FIG. 4, in conjunction with FIGS. 1-3, in step 401, intelligent information disseminator 103 acquires information about subscriber 101. In one embodiment, subscriber 101 may enter information to be stored in a profile via a user interface which may be a web-accessible site or a stand-alone application dedicated to the profile acquisition and management task, or application with which subscriber 101 may interact for some other primary purpose. Additionally, as discussed above, subscriber profile information may be harvested, with the subscriber's permission and subject to technical and legal limitations, from other online sources, such as social network sites, talk-focused sites or applications that may contain relevant information about the subscriber, commerce-oriented sites or other structured descriptions of personal information such as FOAF (Friend of a Friend) files.

In step 402, intelligent information disseminator 103 creates a profile of subscriber 101 using the information obtained in step 401.

In step 403, intelligent information disseminator 103 identifies potential topic(s) of interest of subscriber 101 based on the profile and external knowledge sources (e.g., external data stores 303) using subscriber-interest determination rules, where the potential topic of interest(s) are represented as pointers to concepts.

In step 404, intelligent information disseminator 103 derives a rationale from the subscriber-interest determination rules used to determine potential interest of subscriber 101. For example, referring to the example above involving Magnum P.I., the rationale for identifying documents pertaining to Tom Selleck may be that subscriber 101 may potentially be interested in documents that discuss the main star of television shows, such as Magnum P.I., that subscriber 101 enjoys watching.

In step 405, intelligent information disseminator 103 identifies concepts contained in documents produced by publishers 102.

In step 406, intelligent information disseminator 103 associates each identified concept with that document.

In step 407, intelligent information disseminator 103 compares the identified concepts in published documents with the identified concepts of interest of subscriber 101.

In step 408, intelligent information disseminator 103 identifies those documents(s) published by publishers 102 whose identified concepts match the concepts representing the potential topics of interest of subscriber 101. “Matching,” as used herein, may refer to exceeding some match-quality threshold.

In step 409, intelligent information disseminator 103 notifies subscriber 101 of those identified document(s).

In step 410, intelligent information disseminator 103 receives a request to retrieve the identified content. For example, as discussed above, in the embodiment where pointers (or links) to information are included in the notification, subscriber 101 may easily click on or otherwise activate those links so as to retrieve the indicated content.

In step 411, intelligent information disseminator 103 provides the requested content to subscriber 101.

In step 412, intelligent information disseminator 103 receives feedback regarding the quality of the matching. That is, intelligent information disseminator 103 receives feedback regarding the quality of the documents identified whose concepts representing the potential topics of interest of subscriber 101 match the concepts identified in the documents produced by publishers 102.

In step 413, intelligent information disseminator 103 modifies the subscriber-interest determination rules and/or which concepts are to be identified in the documents published by publishers 102 (i.e., concept tagging) in response to feedback from subscriber 101. For example, subscriber 101 may view the rationale for a particular document having been matched to that subscriber 101 and elect to indicate that the underlying interest-determining rule should no longer be used for that particular subscriber 101. Subscriber 101 may also indicate that matches based on certain specific terms or concepts are not appropriate for that subscriber 101.

Based on the cumulative feedback from subscribers 101, the concept tagging and/or subscriber-interest determination rules may be modified in an automated or semi-automated way so as to improve the overall document/subscriber matching behavior. For example, suppose a subscriber-interest determination rule states that if subscriber 101 is interested in the concept of sports and a document published by publisher 102 discusses the string term “bat” in connection with the concept of sports, then the string term “bat” refers to the concept of baseball bat. However, subscriber 101 may provide feedback indicating that the rationale is improper as the document relates to ice hockey which discusses the Austin Ice Bats, a former minor league hockey team. As a result, this subscriber-interest determination rule will be modified to indicate that the concept of “baseball” needs to be discussed in connection with the string term “bat” in order to conclude that the term refers to the concept of baseball bat. Furthermore, the concept tagging process may be modified in that the document published by publisher 102 may not be tagged for baseball bats unless the string term “bat” is used in connection with the concept of “baseball” instead of just “sports.”

Method 400 may include other and/or additional steps that, for clarity, are not depicted. Further, method 400 may be executed in a different order presented and that the order presented in the discussion of FIG. 4 is illustrative. Additionally, certain steps in method 400 may be executed in a substantially simultaneous manner or may be omitted.

Although the method, system and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims.

1. A method for identifying documents of interest, the method comprising:
identifying potential topics of interests of a subscriber based on a profile of said subscriber and knowledge sources using subscriber-interest determination rules, wherein said potential topics of interests are represented as pointers to concepts;
identifying concepts contained in each of a plurality of documents;
associating each identified concept with that document;
comparing said identified concepts in said plurality of documents with said concepts representing said potential topics of interests of said subscriber; and
identifying one or more documents in said plurality of documents whose concepts match with said concepts representing said potential topics of interests of said subscriber.

2. The method as recited in claim 1 further comprising:
acquiring information about said subscriber; and
creating said profile of said subscriber based on said acquired information about said subscriber.

3. The method as recited in claim 1 further comprising:
notifying said subscriber of said identified one or more documents.

4. The method as recited in claim 3, wherein said notification comprises one or more of the following: one or more titles of said identified one or more documents, one or more pointers to said identified one or more documents, one or more rationales for selecting said identified one or more documents, and full text of said identified one or more documents.

5. The method as recited in claim 3 further comprising:
receiving a request from said subscriber to retrieve one or more of said identified one or more documents.

6. The method as recited in claim 5 further comprising:
providing said requested one or more of said identified one or more documents to said subscriber.

7. The method as recited in claim 1 further comprising:
receiving feedback from said subscriber regarding a quality of said identification of one or more documents in said plurality of documents whose concepts match with said concepts representing said potential topics of interests of said subscriber.

8. The method as recited in claim 7 further comprising:
modifying said subscriber-interest determination rules in response to said feedback from said subscriber.

9. The method as recited in claim 7 further comprising:
modifying which concepts are to be identified in each of said plurality of documents in response to said feedback from said subscriber.

10. The method as recited in claim 1 further comprising:
generating assertions by applying said subscriber-interest determination rules to said profile of said subscriber and to said knowledge sources, wherein said assertions are stored in a model.

11. The method as recited in claim 10, wherein said assertions are assigned to one or more categories.

12. The method as recited in claim 10, wherein said assertions are stored in said model using predicate calculus.

13. The method as recited claim 1, wherein each of said concepts representing said potential topics of interests of said subscriber has a unique identifier.

14. The method as recited in claim 1, wherein said identified potential topics of interests of said subscriber are represented in a structured fashion.

15. The method as recited in claim 1 further comprising:
deriving a rationale for identifying a potential topic of interest using said subscriber-interest determination rules.

16. The method as recited in claim 1, wherein said identified potential topics of interests of said subscriber and associated rationales for said identified potential topics of interests of said subscriber based on said subscriber-interest determination rules are represented in a structured fashion.

17. A computer program product embodied in a computer readable storage medium for identifying documents of interest, the computer program product comprising the programming instructions for:
identifying potential topics of interests of a subscriber based on a profile of said subscriber and knowledge sources using subscriber-interest determination rules, wherein said potential topics of interests are represented as pointers to concepts;
identifying concepts contained in each of a plurality of documents;
associating each identified concept with that document;
comparing said identified concepts in said plurality of documents with said concepts representing said potential topics of interests of said subscriber; and
identifying one or more documents in said plurality of documents whose concepts match with said concepts representing said potential topics of interests of said subscriber.

18. The computer program product as recited in claim 17 further comprising the programming instructions for:
acquiring information about said subscriber; and
creating said profile of said subscriber based on said acquired information about said subscriber.

19. The computer program product as recited in claim 17 further comprising the programming instructions for:
notifying said subscriber of said identified one or more documents.

20. The computer program product as recited in claim 19, wherein said notification comprises one or more of the following: one or more titles of said identified one or more documents, one or more pointers to said identified one or more documents, one or more rationales for selecting said identified one or more documents, and full text of said identified one or more documents.

21. The computer program product as recited in claim 19 further comprising the programming instructions for:
receiving a request from said subscriber to retrieve one or more of said identified one or more documents.

22. The computer program product as recited in claim 21 further comprising the programming instructions for:
providing said requested one or more of said identified one or more documents to said subscriber.

23. The computer program product as recited in claim 17 further comprising the programming instructions for:
receiving feedback from said subscriber regarding a quality of said identification of one or more documents in said plurality of documents whose concepts match with said concepts representing said potential topics of interests of said subscriber.

24. The computer program product as recited in claim 23 further comprising the programming instructions for:
modifying said subscriber-interest determination rules in response to said feedback from said subscriber.

25. The computer program product as recited in claim 23 further comprising the programming instructions for:
modifying which concepts are to be identified in each of said plurality of documents in response to said feedback from said subscriber.

26. The computer program product as recited in claim 17 further comprising the programming instructions for:
generating assertions by applying said subscriber-interest determination rules to said profile of said subscriber and to said knowledge sources, wherein said assertions are stored in a model.

27. The computer program product as recited in claim 26, wherein said assertions are assigned to one or more categories.

28. The computer program product as recited in claim 26, wherein said assertions are stored in said model using predicate calculus.

29. The computer program product as recited claim 17, wherein each of said concepts representing said potential topics of interests of said subscriber has a unique identifier.

30. The computer program product as recited in claim 17, wherein said identified potential topics of interests of said subscriber are represented in a structured fashion.

31. The computer program product as recited in claim 17 further comprising the programming instructions for:
deriving a rationale for identifying a potential topic of interest using said subscriber-interest determination rules.

32. The computer program product as recited in claim 17, wherein said identified potential topics of interests of said subscriber and associated rationales for said identified potential topics of interests of said subscriber based on said subscriber-interest determination rules are represented in a structured fashion.

33. A system, comprising:
a memory unit for storing a computer program for identifying documents of interest; and
a processor coupled to said memory unit, wherein said processor, responsive to said computer program, comprises:
circuitry for identifying potential topics of interests of a subscriber based on a profile of said subscriber and knowledge sources using subscriber-interest determination rules, wherein said potential topics of interests are represented as pointers to concepts;
circuitry for identifying concepts contained in each of a plurality of documents;
circuitry for associating each identified concept with that document;
circuitry for comparing said identified concepts in said plurality of documents with said concepts representing said potential topics of interests of said subscriber; and
circuitry for identifying one or more documents in said plurality of documents whose concepts match with said concepts representing said potential topics of interests of said subscriber.

34. The system as recited in claim 33, wherein said processor further comprises:
circuitry for acquiring information about said subscriber; and
circuitry for creating said profile of said subscriber based on said acquired information about said subscriber.

35. The system as recited in claim 33, wherein said processor further comprises:
circuitry for notifying said subscriber of said identified one or more documents.

36. The system as recited in claim 35, wherein said notification comprises one or more of the following: one or more titles of said identified one or more documents, one or more pointers to said identified one or more documents, one or more rationales for selecting said identified one or more documents, and full text of said identified one or more documents.

37. The system as recited in claim 35, wherein said processor further comprises:
circuitry for receiving a request from said subscriber to retrieve one or more of said identified one or more documents.

38. The system as recited in claim 37, wherein said processor further comprises:
circuitry for providing said requested one or more of said identified one or more documents to said subscriber.

39. The system as recited in claim 33, wherein said processor further comprises:
circuitry for receiving feedback from said subscriber regarding a quality of said identification of one or more documents in said plurality of documents whose concepts match with said concepts representing said potential topics of interests of said subscriber.

40. The system as recited in claim 39, wherein said processor further comprises:
circuitry for modifying said subscriber-interest determination rules in response to said feedback from said subscriber.

41. The system as recited in claim 39, wherein said processor further comprises:
circuitry for modifying which concepts are to be identified in each of said plurality of documents in response to said feedback from said subscriber.

42. The system as recited in claim 33, wherein said processor further comprises:
circuitry for generating assertions by applying said subscriber-interest determination rules to said profile of said subscriber and to said knowledge sources, wherein said assertions are stored in a model.

43. The system as recited in claim 42, wherein said assertions are assigned to one or more categories.

44. The system as recited in claim 42, wherein said assertions are stored in said model using predicate calculus.

45. The system as recited claim 33, wherein each of said concepts representing said potential topics of interests of said subscriber has a unique identifier.

46. The system as recited in claim 33, wherein said identified potential topics of interests of said subscriber are represented in a structured fashion.

47. The system as recited in claim 33, wherein said processor further comprises:
circuitry for deriving a rationale for identifying a potential topic of interest using said subscriber-interest determination rules.

48. The system as recited in claim 33, wherein said identified potential topics of interests of said subscriber and associated rationales for said identified potential topics of interests of said subscriber based on said subscriber-interest determination rules are represented in a structured fashion.
